(19) United States
(12) Patent Application Publication
(10) Pub. No.: US 2022/0048520 A1
(43) Pub. Date: Feb. 17, 2022

(54) VEHICLE AND CONTROL METHOD FOR VEHICLE

(71) Applicant: Toyota Jidosha Kabushiki Kaisha, Toyota-shi Aichi-ken (JP)

(72) Inventors: Aya Sato, Miyoshi-shi (JP); Kuniaki Jinnai, Nagoya-shi (JP); Kenichi Yamada, Nisshin-shi (JP); Hiroaki Takeyama, Nagoya-shi (JP); Taylor Wright, Toyota-shi (JP); Nutonya L. Parker-Harris, Dallas, TX (US)

(21) Appl. No.: 17/397,077

(22) Filed: Aug. 9, 2021

(30) Foreign Application Priority Data
Aug. 11, 2020 (JP) 2020-136066

(51) Int. Cl. B60W 40/09; G06K 9/00; B60W 10/30; B60K 35/00; B60H 1/00

(52) U.S. Cl. CPC B60W 40/09; G06K 9/00838; B60W 10/30; B60K 35/00; B60H 1/00742; B60W 2540/22; B60W 2556/45; B60K 2370/21; B60K 2370/152; B60K 2370/157; B60W 2420/42; B60W 2540/221

(57) ABSTRACT

A vehicle includes a camera configured to capture an image of the interior of a vehicle, an output apparatus configured to output an image and a sound, a scent output apparatus configured to output a scent, and a control apparatus. The control apparatus is configured to determine whether only a pet or only an infant is on board the vehicle based on an image captured by the camera, and upon determining that only a pet or only an infant is on board the vehicle, execute an anxiety reduction action to output an image, a sound, and/or a scent.

### CROSS-REFERENCE TO RELATED APPLICATION

This application claims priority to Japanese Patent Application No. 2020-136066, filed Aug. 11, 2020, the entire contents of which are incorporated herein by reference.

### TECHNICAL FIELD

The present disclosure relates to a vehicle and a control method for a vehicle.

### BACKGROUND

Living bodies, such as pets, that cannot communicate with people by language are incapable of conveying their own mental state and physical condition to others by language. Therefore, such living bodies need to be protected by a guardian.

For example, patent literature (PTL) 1 discloses technology for capturing a facial image of a pet and judging the physical condition of the pet based on the captured facial image. When it is judged that the physical condition of the pet is abnormal, a warning is presented to the owner who is with the pet. The owner, who is the guardian of the pet, can thereby learn that the physical condition of the pet is abnormal and take appropriate measures.

### CITATION LIST

### Patent Literature

PTL 1: JP 2009-165416 A

### SUMMARY

When the owner is not in the vicinity of the pet, the owner cannot learn the mental state of the pet with the technology disclosed in PTL 1.

There is room for improvement in technology for stabilizing the mental state of a living organism, such as a pet, in need of protection by a guardian in the case in which the guardian of the living organism is not in the vicinity of the living organism.

It would be helpful to improve in technology for stabilizing the mental state of a living organism in need of protection by a guardian in the case in which the guardian of the living organism is not in the vicinity of the living organism.

A vehicle according to the present disclosure includes:

a camera configured to capture an image of an interior of a vehicle;

an output apparatus configured to output an image and a sound;

a scent output apparatus configured to output a scent; and

a control apparatus, wherein

the control apparatus is configured to

determine whether only a pet or only an infant is on board the vehicle based on an image captured by the camera, and

upon determining that only a pet or only an infant is on board the vehicle, execute an anxiety reduction action to output an image, a sound, and/or a scent.

A control method according to the present disclosure is a control method for a vehicle including:

a camera configured to capture an image of an interior of a vehicle;

an output apparatus configured to output an image and a sound; and

a scent output apparatus configured to output a scent, and

the control method includes:

determining whether only a pet or only an infant is on board the vehicle based on an image captured by the camera; and

executing, upon determining that only a pet or only an infant is on board the vehicle, an anxiety reduction action to output an image, a sound, and/or a scent.

The present disclosure can improve technology for stabilizing the mental state of a living organism in need of protection by a guardian in the case in which the guardian of the living organism is not in the vicinity of the living organism.

### BRIEF DESCRIPTION OF THE DRAWINGS

In the accompanying drawings:

FIG. 1 is a diagram illustrating a configuration of a vehicle control system according to an embodiment of the present disclosure;

FIG. 2 is a block diagram illustrating a configuration of a vehicle according to an embodiment of the present disclosure;

FIG. 3 is a block diagram illustrating a configuration of a terminal apparatus according to an embodiment of the present disclosure; and

FIG. 4 is a flowchart illustrating operations of a vehicle according to an embodiment of the present disclosure.

### DETAILED DESCRIPTION

Embodiments of the present disclosure are described below with reference to the drawings.

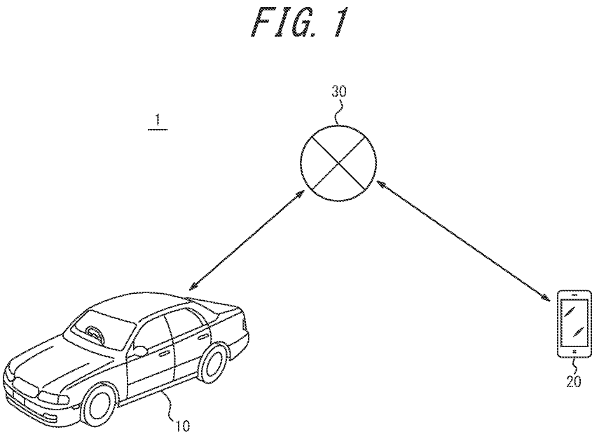

FIG. 1 is a diagram illustrating a configuration of a vehicle control system 1 according to an embodiment of the present disclosure. With reference to FIG. 1, a configuration and outline of the vehicle control system 1 according to an embodiment of the present disclosure are described.

The vehicle control system 1 includes a vehicle 10 and a terminal apparatus 20. The vehicle 10 and the terminal apparatus 20 are communicably connected via a network 30. The network 30 may be a network including a mobile communication network, the Internet, or the like.

In FIG. 1, one each of the vehicle 10 and the terminal apparatus 20 are illustrated, but the number of vehicles 10 and terminal apparatuses 20 may be two or more of each.

The vehicle 10 is any appropriate type of automobile, such as a gasoline-powered vehicle, a diesel-powered vehicle, a hybrid vehicle (HV), a plug-in hybrid vehicle (PHV), an electric vehicle (EV), or a fuel cell vehicle (FCV). Driving of the vehicle 10 may be automated at any level. The level of automation is, for example, one of level 1 to level 5 in the level classification of the Society of Automotive Engineers (SAE). The vehicle 10 may be a Mobility as a Service (MaaS) dedicated vehicle. The vehicle 10 can communicate with the terminal apparatus 20 via the network 30.

The vehicle 10 determines whether only a pet or only an infant, which are living bodies in need of protection by a guardian, is on board the vehicle 10. Upon determining that only a pet or only an infant is on board, the vehicle 10 executes an anxiety reduction action for reducing the anxiety of the pet or infant. The anxiety reduction action is an action to output an image, a sound, and/or a scent. A pet or infant may feel anxious if the guardian is not also on board the vehicle 10, but the anxiety felt by the pet or infant can be reduced by the vehicle 10 executing the anxiety reduction action.

The terminal apparatus 20 is an apparatus owned by the guardian of a pet or infant. The guardian may be the driver of the vehicle 10 or may be someone other than the driver. The person who is the guardian of the pet or infant can be set in advance in the vehicle 10.

The terminal apparatus 20 may, for example, be a smartphone or tablet. The terminal apparatus 20 can communicate with the vehicle 10 via the network 30.

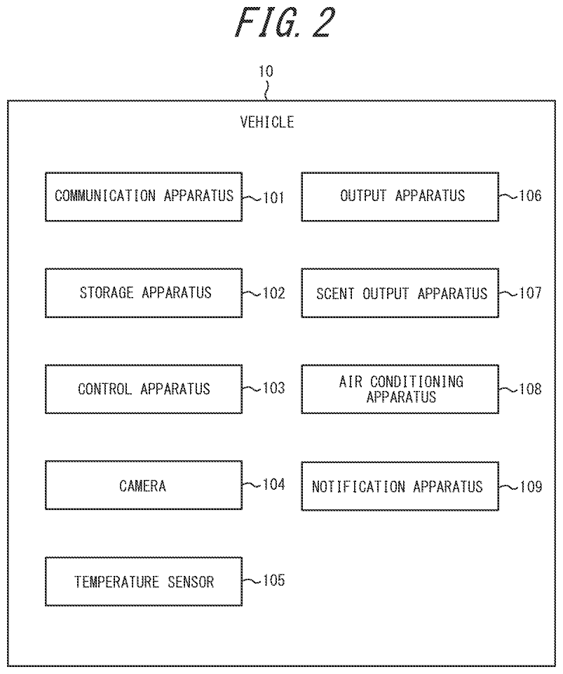

With reference to FIG. 2, a configuration of the vehicle 10 according to an embodiment of the present disclosure is described.

The vehicle 10 includes a communication apparatus 101, a storage apparatus 102, a control apparatus 103, a camera 104, a temperature sensor 105, an output apparatus 106, a scent output apparatus 107, an air conditioning apparatus 108, and a notification apparatus 109. The communication apparatus 101, the storage apparatus 102, the control apparatus 103, the camera 104, the temperature sensor 105, the output apparatus 106, the scent output apparatus 107, the air conditioning apparatus 108, and the notification apparatus 109 are, for example, communicably connected to each other via a vehicle-mounted network, such as a controller area network (CAN), or a dedicated line.

The communication apparatus 101 includes a communication module that connects to the network 30. For example, the communication apparatus 101 may include a communication module compliant with mobile communication standards such as Long Term Evolution (LTE), 4th Generation (4G), and 5th Generation (5G). In an embodiment, the vehicle 10 is connected to the network 30 via the communication apparatus 101. The communication apparatus 101 transmits and receives various information via the network 30. The communication apparatus 101 can communicate with the terminal apparatus 20 via the network 30.

The storage apparatus 102 is, for example, a semiconductor memory, a magnetic memory, an optical memory, or the like, but is not limited to these. The storage apparatus 102 may, for example, function as a main memory, an auxiliary memory, or a cache memory. The storage apparatus 102 stores any information used for operations of the vehicle 10. For example, the storage apparatus 102 may store a system program, an application program, various types of information received by the communication apparatus 101, and the like. The information stored in the storage apparatus 102 may, for example, be updated with information received from the network 30 via the communication apparatus 101.

The control apparatus 103 includes at least one processor, at least one dedicated circuit, or a combination thereof. The processor is a general purpose processor, such as a central processing unit (CPU) or a graphics processing unit (GPU), or a dedicated processor specialized for a particular process. The dedicated circuit is, for example, a field-programmable gate array (FPGA) or an application specific integrated circuit (ASIC). The control apparatus 103 executes processing related to operations of the vehicle 10 while controlling each component of the vehicle 10.

The camera 104 is configured to capture images of the interior of the vehicle 10. The camera 104 may be a dedicated camera or a camera built into another device, such as a drive recorder. The camera 104 captures pets and people on board the vehicle 10. The images captured by the camera 104 may be moving images or still images.

The temperature sensor 105 is configured to detect the body temperature of pets and people on board the vehicle 10. The temperature sensor 105 may, for example, include an infrared temperature sensor or thermography. The temperature sensor 105 may also be configured to detect the temperature of the interior of the vehicle 10.

The output apparatus 106 is configured to output images and sound. The output apparatus 106 includes a display for outputting images. The output apparatus 106 includes a speaker for outputting sound. The output apparatus 106 outputs various images and sounds in response to control by the control apparatus 103.

The scent output apparatus 107 is configured to output a scent. The scent output apparatus 107 outputs various scents in response to control by the control apparatus 103. The scent output apparatus 107 may, for example, be equipped with several types of scent cartridges. The scent output apparatus 107 may, for example, output scent to the outside by a fan.

The air conditioning apparatus 108 can blow hot air or cold air. The air conditioning apparatus 108 has an air conditioning function for adjusting the temperature of the interior of the vehicle 10 by blowing hot air or cold air.

The notification apparatus 109 can issue a warning to the vicinity of the vehicle 10 by sound. The notification apparatus 109 includes a speaker configured to output sound to the vicinity of the vehicle 10.

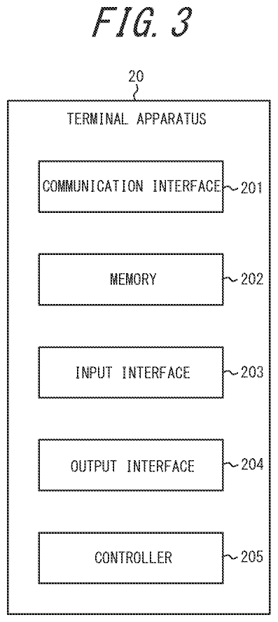

With reference to FIG. 3, the configuration of the terminal apparatus 20 according to an embodiment of the present disclosure is described.

The terminal apparatus 20 includes a communication interface 201, a memory 202, an input interface 203, an output interface 204, and a controller 205

The communication interface 201 includes a communication module that connects to the network 30. For example, the communication interface 201 may include a communication module compliant with a mobile communication standard such as LTE, 4G, and 5G. In an embodiment, the terminal apparatus 20 is connected to the network 30 via the communication interface 201. The communication interface 201 transmits and receives various information via the network 30. The communication interface 201 can communicate with the vehicle 10 via the network 30.

The memory 202 is, for example, a semiconductor memory, a magnetic memory, an optical memory, or the like, but is not limited to these. The memory 202 may, for example, function as a main memory, an auxiliary memory, or a cache memory. The memory 202 stores any information used for operations of the terminal apparatus 20. For example, the memory 202 may store a system program, an application program, various types of information received by the communication interface 201, and the like. The information stored in the memory 202 may, for example, be updated with information received from the network 30 via the communication interface 201. A portion of the memory 202 may be installed externally to the terminal apparatus 20. In this case, the externally installed portion of the memory 202 may be connected to the terminal apparatus 20 via any appropriate interface.

The input interface 203 includes one or more interfaces for input to detect user input and acquire input information based on user operations. For example, the input interface 203 includes, but is not limited to, a physical key, a capacitive key, a touch screen integrally provided with a display of the output interface 204, or a microphone that accepts audio input.

The output interface 204 includes one or more interfaces for output to output information and notify the user. For example, the output interface 204 includes, but is not limited to, a display for outputting information as images or a speaker for outputting information as audio.

The controller 205 includes at least one processor, at least one dedicated circuit, or a combination thereof. The processor is a general purpose processor, such as a CPU or GPU, or a dedicated processor specialized for a particular process. The dedicated circuit is, for example, an FPGA or an ASIC. The controller 205 executes processing related to operations of the terminal apparatus 20 while controlling each component of the terminal apparatus 20.

(Operations of Vehicle Control System)

Operations of the vehicle control system 1 illustrated in FIG. 1 are described with reference to FIGS. 1 to 3 and the like.

The camera 104 of the vehicle 10 continuously captures images of the interior of the vehicle 10. The control apparatus 103 acquires the images captured by the camera 104. The control apparatus 103 performs image analysis of the images acquired from the camera 104. The control apparatus 103 determines whether a person is on board the vehicle 10 by performing image analysis of images acquired from the camera 104. The control apparatus 103 also determines whether a pet is on board the vehicle 10 by performing image analysis of images acquired from the camera 104.

When it is determined that a person is on board the vehicle 10, the control apparatus 103 determines whether the person on board is an infant by image analysis. The control apparatus 103 may, for example, determine whether the person on board the vehicle is an infant by the size of the person appearing in the image. The control apparatus 103 may, for example, determine whether the person on board the vehicle is an infant by whether the person appearing in the image is sitting in a child seat.

When it is determined that a person is on board the vehicle 10, and that the person is sitting in the driver's seat, the control apparatus 103 determines that the person sitting in the driver's seat is the driver of the vehicle 10.

The control apparatus 103 continuously performs image analysis of the images acquired from the camera 104. When a transition occurs from a state in which the driver appears in the images to a state in which the driver does not appear in the images, the control apparatus 103 determines that the driver has gotten out of the vehicle 10.

When it is determined that the driver has gotten out of the vehicle 10, the control apparatus 103 determines whether only a pet or only an infant is on board the vehicle 10. At this time, if it is determined that a non-infant person other than the driver is on board the vehicle 10, the control apparatus 34 does not determine that “only a pet or only an infant is on board the vehicle 10”. For example, if it is determined that an adult is in the passenger seat, the control apparatus 34 does not determine that “only a pet or only an infant is on board the vehicle 10”.

Upon determining that only a pet or only an infant is on board the vehicle 10, the control apparatus 103 executes an anxiety reduction action for reducing the anxiety felt by the pet or infant. Here, the anxiety reduction action is an action to output an image, a sound, and/or a scent to the interior of the vehicle 10.

By the control apparatus 103 thus executing the anxiety reduction action when only the pet or only the infant is on board the vehicle 10, the vehicle 10 can reduce the anxiety felt by the pet or infant.

In the case of outputting an image or sound, the control apparatus 103 controls the output apparatus 106 to output the image or sound. In the case of outputting a scent, the control apparatus 103 controls the scent output apparatus 107 to output the scent.

The image outputted by the output apparatus 106 when the anxiety reduction action is executed is any appropriate image that can reduce the anxiety of a pet or an infant. The image outputted by the output apparatus 106 may be a moving image or a still image. The output apparatus 106 may, for example, output an image of the guardian smiling, an image of a toy, an animated cartoon, or the like. The data of the image outputted by the output apparatus 106 is stored in the storage apparatus 102.

The sound outputted by the output apparatus 106 when the anxiety reduction action is executed is any appropriate sound that can reduce the anxiety of a pet or an infant. The output apparatus 106 may, for example, output the guardian's voice, a song, music, or the like. The data of the sound outputted by the output apparatus 106 is stored in the storage apparatus 102.

The scent outputted by the scent output apparatus 107 when the anxiety reduction action is executed is any appropriate scent that can reduce the anxiety of a pet or an infant. The scent output apparatus 107 may, for example, output a scent of the guardian, a scent of a plant, a scent of food, or the like.

When executing the anxiety reduction action, the control apparatus 103 may execute the anxiety reduction action continuously or intermittently. Regardless of whether the anxiety reduction action is executed continuously or intermittently, the control apparatus 103 may switch the content of the outputted image, sound, and scent over time. The control apparatus 103 may switch the content of the outputted image, sound, and scent at predetermined time intervals or may switch randomly.

The control apparatus 103 may output only one from among an image, a sound, and a scent, or may output a combination of a plurality of these.

The camera 104 also captures images of the interior of the vehicle 10 while the control apparatus 103 is executing the anxiety reduction action. The control apparatus 103 performs image analysis of the images acquired from the camera 104 during the execution of the anxiety reduction action. The control apparatus 103 determines the degree of anxiety, which is an index of anxiety felt by a pet or an infant, by performing image analysis of the image acquired from the camera 104 during the execution of the anxiety reduction action. The control apparatus 103 may, for example, determine the degree of anxiety by analyzing the expression of the pet or infant.

When executing the anxiety reduction action intermittently, the control apparatus 103 may adjust the time interval for executing the anxiety reduction action intermittently in accordance with the determined degree of anxiety. The control apparatus 103 may, for example, shorten the time interval for executing the anxiety reduction action intermittently as the degree of anxiety is greater.

The control apparatus 103 may change the type of image, sound, or scent outputted during execution of the anxiety reduction action in accordance with the determined degree of anxiety. For example, as the degree of anxiety is greater, the control apparatus 103 may change the type of image, audio, or scent so that an image, sound, or scent that is more effective in reducing anxiety is outputted.

Upon execution of the anxiety reduction action, the control apparatus 103 determines the effect of reducing anxiety felt by the pet or infant based on an image captured by the camera 104 before execution of the anxiety reduction action and the image captured by the camera 104 after execution of the anxiety reduction action. The control apparatus 103 may determine the effect of reducing anxiety by, for example, calculating the difference between the degree of anxiety determined based on the image captured by the camera 104 before execution of the anxiety reduction action and the degree of anxiety determined based on the image captured by the camera 104 after execution of the anxiety reduction action.

When determining the effect of reducing anxiety, the control apparatus 103 stores the anxiety reduction action that was executed at that time in the storage apparatus 102 in association with the effect of reducing anxiety. The control apparatus 103 may perform machine learning to learn the relationship between the anxiety reduction action and the effect of reducing anxiety based on the data of the anxiety reduction action and the effect of reducing anxiety stored in association and accumulated in this manner.

The temperature sensor 105 is configured to detect the body temperature of the pet or infant. The control apparatus 103 acquires the body temperature of the pet or infant detected by the temperature sensor 105 from the temperature sensor 105.

The control apparatus 103 adjusts the operation of the air conditioning apparatus 108 based on the body temperature of the pet or infant acquired from the temperature sensor 105. The control apparatus 103 adjusts the operation of the air conditioning apparatus 108 so that, for example, the intensity of cooling by the air conditioning apparatus 108 increases as the body temperature of the pet or infant increases.

By performing image analysis of the image acquired from the camera 104 during execution of the anxiety reduction action, the control apparatus 103 determines whether an abnormal condition has occurred in the pet or infant. The control apparatus 103 determines that an abnormal condition has occurred in the pet or infant when, for example, the degree of anxiety is equal to or greater than a predetermined threshold.

When it is determined that an abnormal condition has occurred in the pet or infant, the control apparatus 103 transmits a warning via the communication apparatus 101 to the terminal apparatus 20 of the guardian of the pet or infant. This enables the guardian holding the terminal apparatus 20 that receives the warning to recognize that an abnormal condition has occurred in the pet or infant and to return to the vehicle 10 to protect the pet or infant.

When it is determined that an abnormal condition has occurred in the pet or infant, the control apparatus 103 may cause the notification apparatus 109 to issue the warning. The notification apparatus 109 can issue the warning to the vicinity of the vehicle 10. Therefore, even if the guardian of the pet or infant is not in the vicinity of the vehicle 10, a person near the vehicle 10 can become aware of the abnormality in the pet or infant and protect the pet or infant.

The warning issued by the notification apparatus 109 may include a message indicating permission to damage the vehicle 10. The inclusion of such a message enables a person who is in the vicinity of the vehicle 10 and becomes aware of the abnormality in the pet or infant to break a window or the like of the vehicle 10 without hesitation to protect the pet or infant.

In this way, when it is determined that an abnormal condition has occurred in the pet or infant, the control apparatus 103 issues a warning with the notification apparatus 109. The vehicle 10 can thereby improve the safety of the pet or infant even when the guardian is not in the vicinity of the pet or infant.

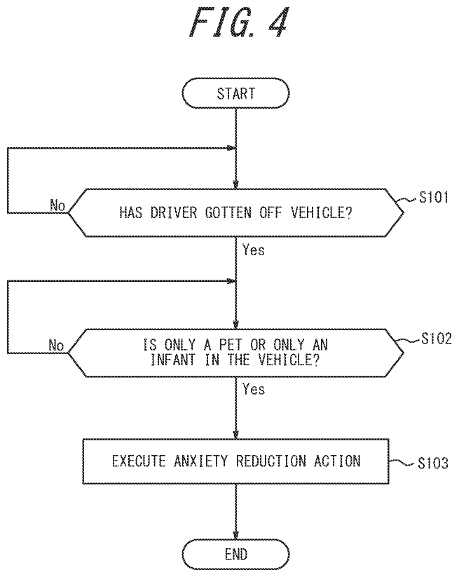

Operations of the vehicle 10 are described with reference to the flowchart illustrated in FIG. 4.

In step S101, the control apparatus 103 of the vehicle 10 determines whether the driver has gotten off the vehicle 10. When it is determined that the driver has not gotten off the vehicle 10 (step S101: No), the control apparatus 103 repeats the operation of step S101. When it is determined that the driver has gotten off the vehicle 10 (step S101: Yes), the control apparatus 103 advances to step S102.

In step S102, the control apparatus 103 determines whether only a pet or only an infant is on board the vehicle 10. When it is determined that a person other than a pet or an infant is also on board the vehicle 10 (step S102: No), the control apparatus 103 repeats the operation of step S102. When it is determined that only a pet or only an infant is on board the vehicle 10 (step S102: Yes), the control apparatus 103 advances to step S103.

In step S103, the control apparatus 103 executes an anxiety reduction action.

As described above, in the vehicle 10 according to the present embodiment, the control apparatus 103 determine whether only a pet or only an infant is on board based on the image captured by the camera 104. Upon determining that only a pet or only an infant is on board the vehicle, the control apparatus 103 executes an anxiety reduction action to output an image, a sound, and/or a scent. Thus, even when only a pet or only an infant is riding on the vehicle 10 and no guardian is in the vicinity of the pet or infant, the anxiety of the pet or infant can be reduced, and the mental state of the pet or infant can be stabilized. The vehicle 10 according to the present disclosure can therefore improve technology for stabilizing the mental state of a living organism, such as a pet or an infant, in need of protection by a guardian in the case in which the guardian of the living organism is not in the vicinity of the living organism.

The present disclosure is not limited to the above-described embodiments. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

For example, a general purpose electronic device, such as a computer, can also be configured to function as the control apparatus 103 of the vehicle 10 according to the above-described embodiment. Specifically, a program describing the processing content for realizing the functions of the control apparatus 103 of the vehicle 10 and the like according to the embodiment can be stored in a memory of the electronic device, and the program can be read and executed by the processor of the electronic device. Accordingly, the present disclosure can also be embodied as a program executable by a processor.

For example, in the above-described embodiment, a pet and an infant have been described as examples of the living body in need of protection by a guardian, but the living body in need of protection by a guardian is not limited to these examples. Examples of living bodies in need of protection by a guardian include elderly people, dementia patients, and the like.

1. A vehicle comprising:
a camera configured to capture an image of an interior of a vehicle;
an output apparatus configured to output an image and a sound;
a scent output apparatus configured to output a scent; and
a control apparatus, wherein
the control apparatus is configured to
determine whether only a pet or only an infant is on board the vehicle based on an image captured by the camera, and
upon determining that only a pet or only an infant is on board the vehicle, execute an anxiety reduction action to output an image, a sound, and/or a scent.

2. The vehicle of claim 1, wherein the control apparatus is configured to execute the anxiety reduction action continuously.

3. The vehicle of claim 1, wherein the control apparatus is configured to execute the anxiety reduction action intermittently.

4. The vehicle of claim 3, wherein the control apparatus is configured to
determine, based on an image captured by the camera, a degree of anxiety that is an index of anxiety felt by the pet or the infant, and
adjust a time interval for intermittently executing the anxiety reduction action in accordance with the degree of anxiety.

5. The vehicle of claim 1, wherein the control apparatus is configured to
determine, based on an image captured by the camera, a degree of anxiety that is an index of anxiety felt by the pet or the infant, and
change a type of image, sound, and/or scent outputted by the anxiety reduction action in accordance with the degree of anxiety.

6. The vehicle of claim 1, wherein the control apparatus is configured to
determine an effect of reducing anxiety felt by the pet or the infant based on images captured by the camera before and after execution of the anxiety reduction action, and
perform machine learning to learn a relationship between the anxiety reduction action and the effect of reducing anxiety.

7. The vehicle of claim 1, further comprising:
a temperature sensor configured to detect a body temperature of the pet or the infant; and
an air conditioning apparatus, wherein
the control apparatus is configured to adjust operation of the air conditioning apparatus based on the body temperature of the pet or the infant detected by the temperature sensor.

8. The vehicle of claim 1, wherein upon determining that an abnormal condition has occurred in the pet or the infant based on an image captured by the camera, the control apparatus is configured to transmit a warning to a terminal apparatus of a guardian of the pet or the infant.

9. The vehicle of claim 1, further comprising a notification apparatus configured to issue a warning to a vicinity of the vehicle, wherein
upon determining that an abnormal condition has occurred in the pet or the infant based on an image captured by the camera, the control apparatus is configured to cause the notification apparatus to issue the warning. 25

10. The vehicle of claim 9, wherein the warning issued by the notification apparatus includes a message indicating permission to damage the vehicle.

11. A control method for a vehicle, wherein
the vehicle comprises:
a camera configured to capture an image of an interior of a vehicle;
an output apparatus configured to output an image and a sound; and
a scent output apparatus configured to output a scent, and
the control method comprises:
determining whether only a pet or only an infant is on board the vehicle based on an image captured by the camera; and
executing, upon determining that only a pet or only an infant is on board the vehicle, an anxiety reduction action to output an image, a sound, and/or a scent.

12. The control method of claim 11, wherein the executing the anxiety reduction action includes executing the anxiety reduction action continuously.

13. The control method of claim 11, wherein the executing the anxiety reduction action includes executing the anxiety reduction action intermittently.

14. The control method of claim 13, further comprising:
determining, based on an image captured by the camera, a degree of anxiety that is an index of anxiety felt by the pet or the infant; and
adjusting a time interval for intermittently executing the anxiety reduction action in accordance with the degree of anxiety.

15. The control method of claim 11, further comprising:
determining, based on an image captured by the camera, a degree of anxiety that is an index of anxiety felt by the pet or the infant; and
changing a type of image, sound, and/or scent outputted by the anxiety reduction action in accordance with the degree of anxiety.

16. The control method of claim 11, further comprising:
determining an effect of reducing anxiety felt by the pet or the infant based on images captured by the camera before and after execution of the anxiety reduction action; and
performing machine learning to learn a relationship between the anxiety reduction action and the effect of reducing anxiety.

17. The control method of claim 11, wherein
the vehicle further comprises:
a temperature sensor configured to detect a body temperature of the pet or the infant; and
an air conditioning apparatus, and
the control method further comprises adjusting operation of the air conditioning apparatus based on the body temperature of the pet or the infant detected by the temperature sensor.

18. The control method of claim 11, further comprising transmitting a warning to a terminal apparatus of a guardian of the pet or the infant when it is determined that an abnormal condition has occurred in the pet or the infant based on an image captured by the camera.

19. The control method of claim 11, wherein
the vehicle further comprises a notification apparatus configured to issue a warning to a vicinity of the vehicle, and
the control method further comprises causing the notification apparatus to issue the warning when it is determined that an abnormal condition has occurred in the pet or the infant based on an image captured by the camera.

20. The control method of claim 19, wherein the warning issued by the notification apparatus includes a message indicating permission to damage the vehicle.
